(19) United States
(12) Patent Application Publication
(10) Pub. No.: US 2007/0044703 A1
(43) Pub. Date: Mar. 1, 2007

(54) Apparatus and method for retaining a flag

(76) Inventor: Samuel C. Vickroy, Madison, AL (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/510,379

(22) Filed: Aug. 25, 2006

Related U.S. Application Data
(60) Provisional application No. 60/711,304, filed on Aug. 25, 2005.

(51) Int. Cl. G09F 17/00

(52) U.S. Cl. 116/173

(57) ABSTRACT

An apparatus for retaining a flag hanging from a flagpole has a first clip coupled to the flagpole and a second clip coupled to the flag. Additionally, an arm is coupled to the first clip and the second clip so as to retain at least a portion of the flag in an unfurled state while the flag is hanging from the flagpole.

### CROSS REFERENCE TO RELATED APPLICATION

This application claims priority to U.S. Provisional Application No. 60/711,304, entitled “Apparatus and Method for Retaining a Flag,” and filed on Aug. 25, 2005, which is incorporated herein by reference.

### RELATED ART

Oftentimes homeowners display a flag at their house. Typically, the flag being displayed is secured to a flagpole. A bracket is usually mounted on a portion of their house. For example, the bracket may be mounted to a column of a front porch of the house. The flag pole is secured in a particular position, e.g., at a forty-five degree angle or ninety degree angle relative to a surface of the column.

It is most desirous that the flag hang unfurled from the flagpole such that the flag is visible. However, due to weather conditions, e.g., wind, oftentimes the flag furls about the flagpole. In this regard, some homeowners find it desirable to manually unfurl the flag so that the flag is again visible.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a flag retainer coupled to a flag in accordance with an exemplary embodiment of the present disclosure.

FIG. 2 is a perspective view of the flag retainer of FIG. 1.

FIG. 3 is a side view of an exemplary clip of the flag retainer of FIG. 1.

FIG. 4 is a front view of the clip of FIG. 3.

FIG. 5 is a side view of the clip of FIG. 3 in an actuated state.

FIG. 6 is a front view of the clip of FIG. 3 in an actuated state.

FIG. 7 is a flowchart depicting an exemplary method in accordance with an embodiment of the present disclosure.

### DETAILED DESCRIPTION

Embodiments of the present disclosure generally pertain to an apparatus and method for retaining at least a portion of a flag in an unfurled state while the flag is hanging from a flagpole. Particularly, an apparatus of the present disclosure has a clip coupled to the flag pole and a clip coupled to the flag. The clips are connected to one another via an arm. In one embodiment, the clip that is coupled to the flag is slightly rotated about the arm relative to the clip that is coupled to the flagpole. Such slight rotation provides an offset in contrast to the position of the clip coupled to the flagpole such that the flag can be retained at a slight angle from the flagpole.

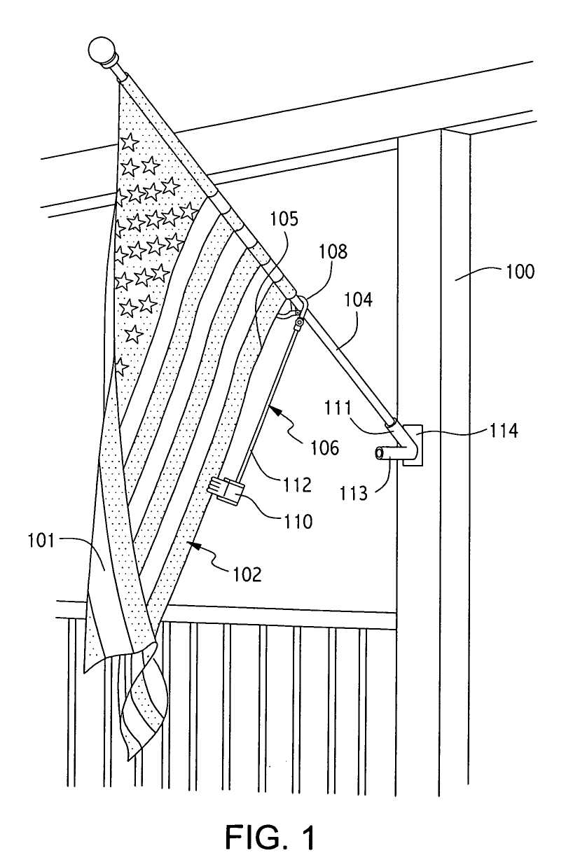

FIG. 1 depicts a flag 102 that is coupled to a flagpole 104. The flag pole 104 is inserted into a bracket 114 that is secured to a portion of a house, for example, a column 100 of a porch. Therefore, the flag 102 hangs in an unfurled state toward the ground (not shown). Notably, the bracket 114 may be configured to accommodate the flagpole 104 at more than one angle relative to the column 100. However, for exemplary purposes, the flagpole 104 is illustrated as being held by the bracket 114 at approximately a forty-five degree angle relative to a surface of the column by the sleeve 111. The sleeve 113 may be used in order to mount the flagpole 104 at a ninety-degree angle relative to the surface of the column 100.

FIG. 1 further depicts a flag retainer 106 in accordance with an exemplary embodiment of the present disclosure. The flag retainer 106 comprises a clip 108 coupled to the flagpole 104 and a clip 110 coupled to the flag 102. The clips 108 and 110 are connected via an arm 106, which is described further herein.

On stormy or breezy days, wind may blow the flag 102 such that the flag 102 wraps around the flag pole 104. However, the flag retainer 106 reduces or eliminates the risk that the flag 102 wraps about the flagpole 104 when there are inclimate weather conditions. In this regard, the flag retainer 106 secures a portion 105 of the flag 102 in a substantially fixed position. As indicated, the flag retainer 106 illustrated in FIG. 1 fixes a portion 105 of the bottom of the flag 102 thereby allowing the flag 102 to drape somewhat at an end 101 of the flag 102 opposing the fixed portion 105. However, the flag 102 is retained such that the flag 102 will not wrap about the flagpole 104.

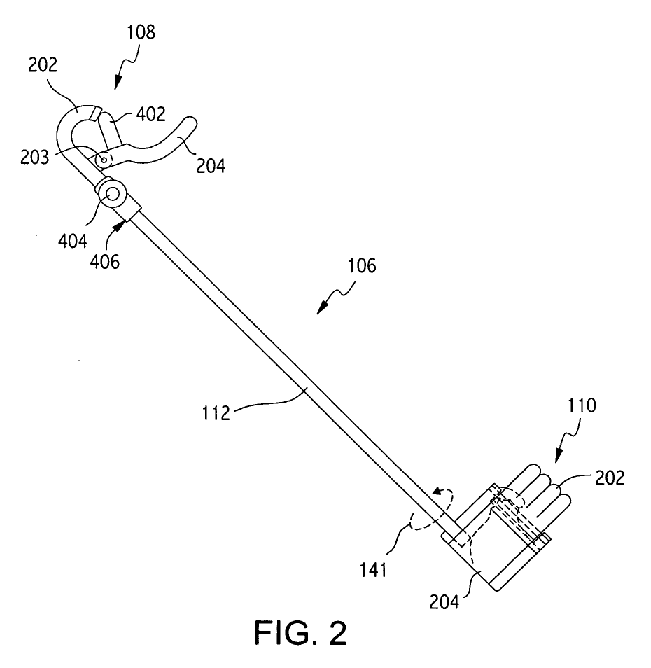

FIG. 2 depicts a perspective view of the flag retainer 106 of FIG. 1. The retainer 106 comprises the clip 108 coupled to the flag pole 104 (FIG. 1) and the clip 110 coupled to the flag 102 (FIG. 1). Further, FIG. 2 depicts the arm 112 coupled to the clips 108 and 110. Note that the clips 108 and 110 and the arm 112 may be made of a light metal or a plastic type material. In one embodiment, the arm 112 consists of a flexible plastic type material such that when wind blows thereby applying force on the arm 112, the arm 112 may deform slightly thereby absorbing some of the force of the wind.

Each clip 108 and 110 comprises a first member 202 and a second member 204 that are pivotally connected via connectors 206. Such connectors 206 may comprise, for example, a screw or a rivet. When a manual force is applied to the member 204, the member 204 rotates about the connectors 206 thereby separating the member 202 and the member 204 so that the clip 108 or 110 can be coupled to the flag pole 104 or the flag 102, respectively.

In one embodiment, each clip 108 and 110 is pivotally coupled to the arm 112, which is described further herein. In this regard, once the clip 108 is coupled to the flagpole 104, a user (not shown) may rotate the clip 110 about the arm 112 in the direction, for example, of reference arrow 141. By rotating the clip 110 about the arm, the user can offset where the clip 110 attaches to the flag, i.e., the clip 110 can pull the flag in one direction or another relative to the clip 108.

Note that each of the clips 108 and 110 have openings 404 and 406. Therefore, each clip 108 and 110 may receive the arm 112 either on its side in opening 404 or at an end of the member 202 at opening 406. Therefore, each of the clips are interchangeable between positions. In this regard, each clip 108 or 110 could be coupled to the flagpole 104 (FIG. 1) or the flag 102 (FIG. 1).

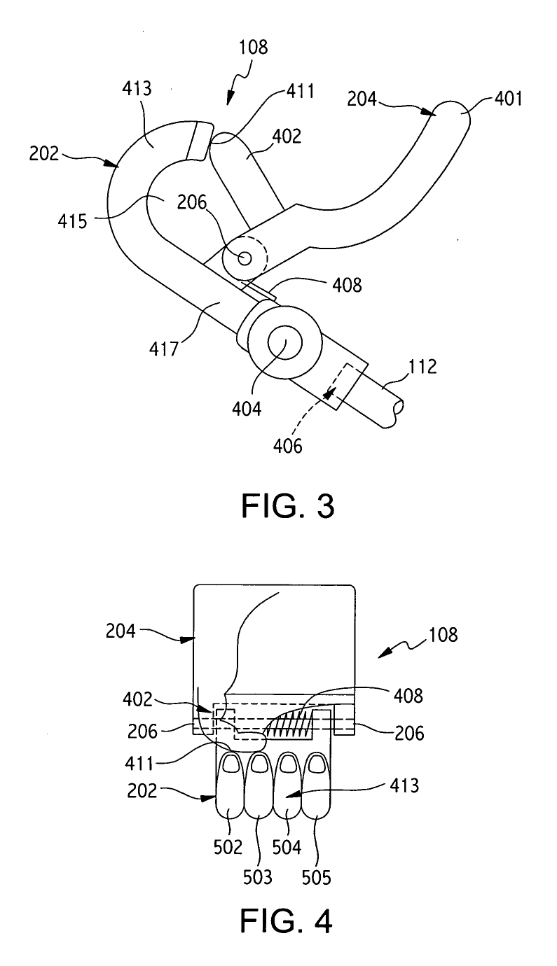

FIG. 3 depicts a side view of a clip 108. Note that clips 108 and 110 are substantially identical in structure. Therefore, for brevity, only clip 108 is described in more detail herein.

Clip 108 comprises the member 202 and the member 204. The members 202 and 204 are pivotally connected via connectors 206. Note that only one of the connectors 206 is shown in the side view of FIG. 3. As indicated hereinabove, the connector 206 may be, for example, a screw or a rivet.

The member 204 comprises a handle 401 and a thumb protrusion 402. Preferably the member 204 is a unitary piece such that the handle 401 and the thumb protrusion 402 are contiguous with one another. Furthermore, the handle 401 is pivotally coupled via the connector 206 to the member 202.

The member 202 comprises a finger extension 413 that is contiguous with a body 417. Thus, in an unactuated position, the thumb protrusion 402 and the finger extension 413 come together at a clamp 411 to form an aperture 415.

Aperture 415 formed by the finger extension 413 and the thumb protrusion 402 is sufficient to retain the flagpole 104 (FIG. 1). Furthermore, the thumb protrusion 402 and the finger extension 413 form the clamp 411. Such a clamp 411 can retain the flag 102. Thus, when the wind blows, the hanging portion 101 (FIG. 1) of the flag 102 (FIG. 1) may move in response to the wind, but the fixed portion 105 (FIG. 1) of the flag 102 between the clamp 110 and flag pole 104 remains substantially fixed by the clamp 411.

In addition, the clip 108 comprises a spring 408 disposed between the member 202 and the member 204. Thus, the spring 408 spring loads the pivotally connected members 202 and 204 such that when the member 204 is actuated, as described further herein, the spring 408 exerts a force to return the member 204 back to the unactuated position as illustrated in FIG. 3.

In one embodiment, the member 202 comprises a plurality of openings 404 and 406 for receiving an arm 112. In this regard, the arm 112 may be inserted into either opening 404 or 406 depending upon the application of the retaining device 106. Furthermore, as described hereinabove, the arm 112 may be pivotally coupled to an inner wall of the openings 406 and 406. Therefore, when the user (not shown) is installing the retainer 106 to a flag 102, the user can rotate the clips 108 and 110 accordingly with respect to the flag 102 and the flagpole 104.

As an example, with reference to FIG. 2, the arm 112 is inserted into the opening 406 (FIG. 3) of clip 108 so that the clip 108 can be coupled to the flag pole 104 (FIG. 1). Consequently, the arm 112 is inserted into the opening 404 (FIG. 3) of the clip 110 so that the clip 110 is positioned alternatively to be coupled to the flag 102.

FIG. 4 depicts a front view of the clip 108 in an unactuated position. As illustrated, when the clip 108 is not actuated, the finger extension 413 contacts the thumb protrusion 402 at contact point 411. Thus, the finger extension 413 and the thumb protrusion 402 hold the flag 102 when the clip 108 is positioned, as described hereinabove, to retain the flag as opposed to retain to the flagpole 104.

Furthermore, the finger extension 413 comprises a plurality of protrusions 502-505 that form a finger extension 413 resembling a plurality of fingers of a hand. Additionally, the thumb portion 412 resembles a thumb of a hand.

FIG. 4 further illustrates the spring 408. The spring 408 is attached at the connections 206 such that when the member 204 is actuated by applying force to the handle 401, as described further herein, the spring 408 allows the member 204 to move such that the thumb protrusion 402 separates from the contact point 411. However, when force is no longer applied to the handle 401, the member 204 returns to a rest position such that the thumb protrusion 402 contacts the finger extension 413.

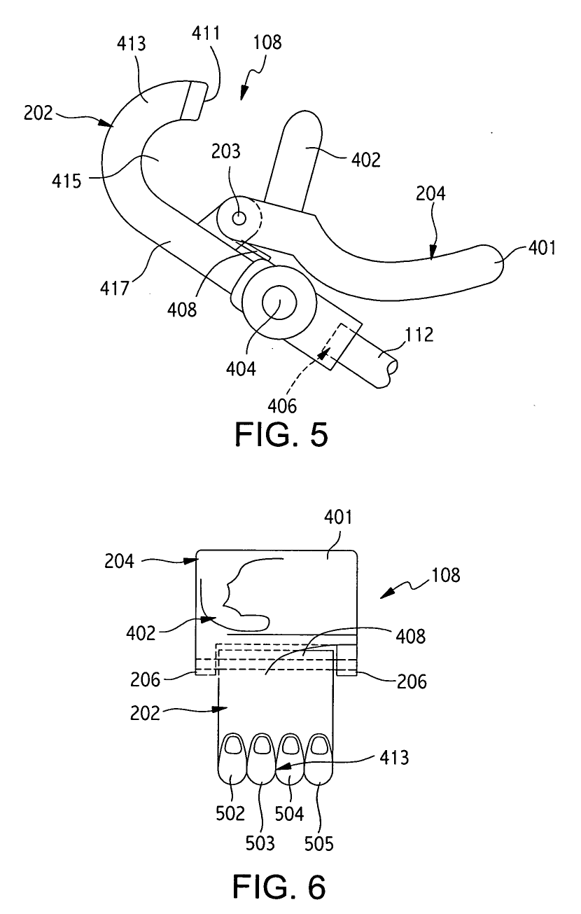

FIG. 5 depicts a side view of the clip 108 in an actuated position. In this regard, when force is applied to the handle 401, the thumb protrusion 402 moves away from the finger extension 413. When the portions 402 and 413 are separated, the clip 108 can be coupled to either a flag 102 (FIG. 1) or a flag pole 104 (FIG. 1) by releasing the handle 401 when the flag 102 or the flag pose 104 is positioned within the aperture 415.

FIG. 6 depicts a front view of the clip 108 in an actuated position. As described hereinabove, when the handle 401 is actuated, the thumb 402 moves away from the finger extension 413 so that the clip 108 can be coupled to a flag 102 (FIG. 1) or a flag pole 104 (FIG. 1). The spring 408 provides tension between the members 202 and 204 such that when the handle 401 is released, the thumb protrusion 402 and the finger extension 413 again re-contact, and the clamp 411 formed by the contact retains the flagpole 104 or the flag 102.

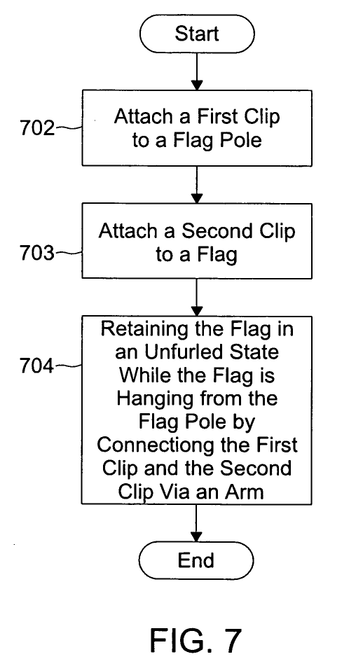

An exemplary method of the flag retainer 106 is illustrated with reference to the flowchart in FIG. 7.

Such method comprises coupling a first clip 108 (FIG. 1) to a flag pole 104 (FIG. 1) in step 702. The next step 703 is coupling a second clip 110 (FIG. 1) to a flag 102 (FIG. 2).

The final step 704 is connecting the first clip 108 and the second clip 110 via an arm 112 (FIG. 1) thereby retaining the flag in an unfurled state while the flag is hanging from the flagpole. Alternatively, either or both clips 108 and/or 110 may be connected to the arm 112 before being coupled to the flag pole 104 or flag 102. Note that embodiments of the apparatus 106 described above may be used to retain/or hold objects other than flags.

Now, therefore, the following is claimed:

1. An apparatus for retaining at least a portion of a flag hanging from a flag pole, the apparatus comprising:
a first clip coupled to the flagpole;
a second clip coupled to the flag; and
an arm coupled to the first clip and the second clip such that at least a portion of the flag is retained in an unfurled state while the flag is hanging from the flagpole, wherein at least one of the clips is rotatable about the arm.

2. The apparatus of claim 1, wherein the first clip comprises a first member pivotally coupled to a second member.

3. The apparatus of claim 2, further comprising a spring, the spring coupled to the first member and the second member.

4. The apparatus of claim 2, wherein the first member comprises four indentations.

5. The apparatus of claim 1, wherein the second clip is offset from the first clip.

6. The apparatus of claim 1, wherein one of the clips has a first member and a second member, the first and second members forming an aperture, wherein the first member is pivotable about a pivot point for contacting the second member.

7. An apparatus for retaining at least a portion of a flag hanging from a flag pole, the apparatus comprising:
an arm;
a first clip coupled to the arm; and
a second clip coupled to the arm, the second clip having a first member and a second member, the first and second members forming an aperture, wherein the first member is pivotable about a pivot point for contacting the second member.

8. The apparatus of claim 7, wherein the second clip further comprises a spring coupled to the first member.

9. The apparatus of claim 8, wherein the spring exerts a force on the first member to cause the first member to pivot about the pivot point and contact the second member.

10. The apparatus of claim 7, wherein the second member has a plurality of fingers.

11. The apparatus of claim 10, wherein the first member has a handle and a protrusion, the protrusion contacting at least one of the fingers.

12. The apparatus of claim 7, wherein the second clip is rotatable about the arm.

13. The apparatus of claim 7, wherein the second clip is coupled to the flag, and wherein the first clip is coupled to the flag pole.

14. The apparatus of claim 7, wherein the second clip is coupled to the flag pole, and wherein the first clip is coupled to the flag.

15. The apparatus of claim 7, wherein the second member has an opening for receiving the arm.

16. A method for retaining at least a portion of a flag hanging from a flag pole, the method comprising the steps of:
coupling a first clip to the flagpole;
coupling a second clip to the flag;
coupling the first and second clips to an arm; and
rotating at least one of the clips about the arm.

17. The method of claim 16, wherein the second clip has a first member and a second member forming an aperture, and wherein the method further comprises the step of pivoting the first member about a pivot point such that the first member contacts the second member.

18. The method of claim 17, wherein the first member is spring-loaded.

19. The method of claim 17, wherein the second member has a plurality of fingers.

20. The method of claim 19, wherein the first member has a handle and a protrusion, and wherein the pivoting step is performed such that the protrusion contacts at least one of the fingers.
